(19) United States
(12) Patent Application Publication
(10) Pub. No.: US 2018/0075227 A1
(43) Pub. Date: Mar. 15, 2018

(54) SYSTEMS AND METHODS FOR SURVEILLANCE OF USER ACCESS TO A SECURITY CRITICAL RESOURCE

(71) Applicant: QUALCOMM Incorporated, San Diego, CA (US)

(72) Inventors: Ahmed Sheikh, Toronto (CA); Shiu Wai Hui, Richmond Hill (CA); Veluppillai Arulesan, Toronto (CA)

(21) Appl. No.: 15/264,207

(22) Filed: Sep. 13, 2016

(51) Int. Cl. G06F 21/32; G06F 21/44

(52) U.S. Cl. CPC G06F 21/32; G06F 21/44

(57) ABSTRACT

A method for surveillance of user access to a security critical resource is described. The method includes receiving a request to access the security critical resource that is pre-specified for surveillance. The method also includes prompting to capture a facial image with a user-facing camera. If a face is detected in the facial image, then the method further includes storing the facial image according to a pre-specified storage policy, and accessing the security critical resource.

### FIELD OF DISCLOSURE

The present disclosure relates generally to electronic devices. More specifically, the present disclosure relates to systems and methods for surveillance of user access to a security critical resource.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., smart phones, tablet computers, laptop computers, desktop computers, etc.) may be configured to access a security critical resource such as a website or application. A security critical resource may be secured using passwords or other authentication procedures before access to the security critical resource is granted. However, an additional layer of security may be desired for monitoring user access to the security critical resource. As can be observed from this discussion, systems and methods for surveillance of user access to a security critical resource may be beneficial.

### SUMMARY

A method for surveillance of user access to a security critical resource is described. The method includes receiving a request to access the security critical resource that is pre-specified for surveillance. The method also includes prompting to capture a facial image with a user-facing camera. If a face is detected in the facial image, then the method further includes storing the facial image according to a pre-specified storage policy, and accessing the security critical resource.

If a face is not detected in the facial image, then the method may further include denying access to the security critical resource. If the facial image is not stored according to the pre-specified storage policy, then the method may further include denying access to the security critical resource. If no image is taken in response to the prompt, then the method may further include denying access to the security critical resource.

Prompting to capture a facial image may also include notifying that the facial image is stored for post-access analysis.

The method may be implemented by a browser. The method may be implemented on a handheld mobile device. The security critical resource may include a website or an application.

Storing the facial image according to the pre-specified storage policy may include at least one of sending the facial image to a pre-specified email address, storing the facial image in a local password protected folder or sending the facial image to a remote storage device. The stored facial image may be made available for post-access analysis.

An electronic device configured for surveillance of user access to a security critical resource is also described. The electronic device includes a processor, a memory in electronic communication with the processor, and instructions stored in the memory. The instructions are executable by the processor to receive a request to access the security critical resource that is pre-specified for surveillance. The instructions are also executable to prompt to capture a facial image with a user-facing camera. If a face is detected in the facial image, then the instructions are further executable to store the facial image according to a pre-specified storage policy, and access the security critical resource.

A computer-program product for surveillance of user access to a security critical resource is also described. The computer-program product includes a non-transitory tangible computer-readable medium having instructions thereon. The instructions include code for causing an electronic device to receive a request to access the security critical resource that is pre-specified for surveillance. The instructions also include code for causing the electronic device to prompt to capture a facial image with a user-facing camera. If a face is detected in the facial image, the instructions further include code for causing the electronic device to store the facial image according to a pre-specified storage policy, and code for causing the electronic device to access the security critical resource.

### BRIEF DESCRIPTION OF THE DRAWINGS

FIG. 1 is a block diagram illustrating an electronic device configured for surveillance of user access to a security critical resource;

FIG. 2 is a flow diagram illustrating a method for surveillance of user access to a security critical resource;

FIG. 3 is a block diagram illustrating a handheld mobile device configured for surveillance of user access to a security critical website;

FIG. 4 is a flow diagram illustrating another method for surveillance of user access to a security critical resource;

FIG. 5 is a flow diagram illustrating a method for configuring surveillance of user access to a security critical resource;

FIG. 6 is a flow diagram illustrating a method for post-access analysis of security critical resource surveillance; and

FIG. 7 illustrates certain components that may be included within an electronic device.

### DETAILED DESCRIPTION

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

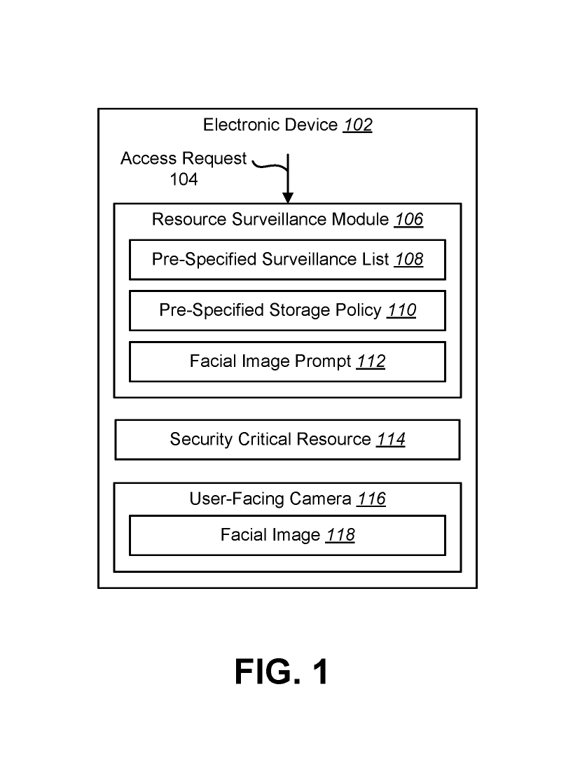

FIG. 1 is a block diagram illustrating an electronic device 102 configured for surveillance of user access to a security critical resource 114. The electronic device 102 may also be referred to as a wireless communication device, a mobile device, mobile station, subscriber station, client, client station, user equipment (UE), remote station, access terminal, mobile terminal, terminal, user terminal, subscriber unit, etc. Examples of electronic devices include laptop or desktop computers, cellular phones, smartphones, wireless modems, e-readers, tablet devices, gaming systems, robots, etc. Some of these devices may operate in accordance with one or more industry standards.

The electronic device 102 may be configured to access a security critical resource 114. As used herein, a security critical resource 114 may be a resource that is accessible by the electronic device 102 to perform a computing operation for which security is a concern. The resource may be designated as a security critical resource 114 by a user or administrator.

A security critical resource 114 may be a website or application that may be accessed by the electronic device 102. For example, a security critical website may include banking, email, etc. A security critical application may be a program (e.g., app) that the electronic device 102 may use to perform a security sensitive activity. For example, the application may be a banking application that is accessed from a smartphone.

A security critical resource 114 may be secured using user credentials. For example, a user may need to enter a username and password before access is granted to the security critical resource 114. However, a security critical resource 114 may benefit from additional layers of security.

One approach to providing additional security is requiring additional passwords. For example, a security critical resource 114 may use two-step authentication that requires entering a unique secondary password to access the security critical resource 114. In another approach, facial recognition may be used to verify the identity of a user attempting to access the security critical resource 114.

These security approaches are focused on authenticating users when accessing the critical information. However, these approaches are resource intense. For example, facial recognition may use significant computing resources (e.g., processing and energy consumption) in the electronic device 102. The two-step authentication may require an external entity (e.g., service) to generate and verify the secondary password. These approaches may limit the number of security critical resources 114 that can be protected. Furthermore, because these approaches are focused on authentication, these approaches do not provide post-access verification of activity on the security critical resource 114.

As can be seen from this discussion, benefits may be realized by a solution that allows a user to review activity on the security critical resource 114 after the data has been accessed on the electronic device 102. The described systems and methods provide for surveillance of a security critical resource 114 in a manner that is computationally inexpensive.

The described systems and methods provide additional security to a security critical resource 114 by allowing a user to monitor the security critical resource 114 when it is used and then review the activity at a later time. These techniques are complementary to authentication and allow a user to check later on (e.g., post-access) if a security critical resource 114 is being used by a malicious user.

The electronic device 102 may include a resource surveillance module 106. In an approach, the resource surveillance module 106 may be implemented as part of the operating system (OS) of the electronic device 102 that monitors a security critical resource 114. In another approach, the resource surveillance module 106 may be implemented in a browser (e.g., web browser) of the electronic device 102.

The resource surveillance module 106 may allow a user to pre-configure which security critical resource 114 should be monitored. A user may configure which resources are considered security critical resources 114. For example, the user may designate one or more websites (e.g., Uniform Resource Locators (URLs)) as security critical resources 114. Additionally, the user may designate one or more applications as security critical resources 114. These user-specified security critical resources 114 may be included in a pre-specified surveillance list 108.

A user may also specify how surveilled images are to be stored. In an implementation, the user may indicate that surveillance images (i.e., facial images 118) should be sent to a pre-specified email address. In another implementation, the user may specify that surveillance images should be stored in a local password protected folder. In yet another implementation, the user may specify that surveillance images should be sent to a remote storage device. These user storage preferences may be saved as a pre-specified storage policy 110. It should be noted that these implementations are provided as examples, and other storage implementations may be utilized.

In an implementation, the configuration of the pre-specified surveillance list 108 and the pre-specified storage policy 110 may be secured. For example, a user may have to enter a password before being allowed to edit the pre-specified surveillance list 108 and the pre-specified storage policy 110. In other words, the user must be authenticated with a password in order for the user to be able to specify a website or application to monitor. This may prevent a malicious user from disabling the surveillance of a security critical resource 114.

The resource surveillance module 106 may receive an access request 104 for the security critical resource 114. For example, the resource surveillance module 106 may monitor requests to access websites or applications. The access request 104 may be received when a user or automated process first attempts to access the security critical resource 114. Additionally, the access request 104 may be received when the security critical resource 114 selected after being minimized or running in the background.

Upon receiving the access request 104, the resource surveillance module 106 may determine whether the access request 104 is for a resource that is included in the pre-specified surveillance list 108. If the resource is not in the pre-specified surveillance list 108, then that resource is not considered security critical and the resource surveillance module 106 may allow access to the resource.

If the resource is included in the pre-specified surveillance list 108, then the resource is considered a security critical resource 114. In this case, the resource surveillance module 106 may issue a facial image prompt 112. The facial image prompt 112 may be a message instructing the user of the electronic device 102 to capture a facial image 118 with a user-facing camera 116.

In an implementation, the facial image prompt 112 may be a message that is displayed in a dialog box on a display screen of the electronic device 102. The facial image prompt 112 may instruct the user to position the user-facing camera 116 such that a photo of the user's face may be captured.

The facial image prompt 112 may also include a notification to the user that the facial image 118 will be stored for post-access analysis (e.g., logging and review). This may act as a further deterrent for malicious activity as a malicious user is put on notice that their activity is being monitored.

The facial image prompt 112 may include an option to accept or decline taking a picture using the user-facing camera 116. If the user declines the facial image prompt 112, then the resource surveillance module 106 may deny access to the security critical resource 114. In other words, if no image is taken in response to the facial image prompt 112, the resource surveillance module 106 may deny access to the security critical resource 114.

It should be noted that in the case of a handheld mobile device (e.g., smartphone), the user-facing camera 116 may be included as part of the handheld mobile device. A handheld mobile device may include multiple cameras. For example, a handheld mobile device may include a front-facing camera and a back facing camera. Either of these cameras may be used to capture the facial image 118. In an implementation, the front-facing camera may be used to provide the user a convenient view of the display screen.

In a case where the electronic device 102 is a laptop or desktop computer, the electronic device 102 may include a single user-facing camera 116. In some cases (as with a desktop computer), the user-facing camera 116 may be separate from the electronic device 102. For example, a webcam may be mounted to a monitor that is attached to the electronic device 102.

If the user accepts the facial image prompt 112, then the resource surveillance module 106 may bring up a camera software application on a display screen. When the camera application is running, images of objects that are located within the field of view of the optical system camera may be recorded by the image sensor. The images that are being recorded by the image sensor may be displayed on the display screen. These images may be displayed in rapid succession at a relatively high frame rate so that, at any given moment in time, the objects that are located within the field of view of the camera are displayed on the display screen.

A user may manually select to take a facial image 118 of themselves. Alternatively, the camera software application may automatically take the facial image 118. For example, the camera software application may display a timer to allow a user to orient the user-facing camera 116 on their face. In an implementation, the camera software application may project an outline of a face on the display screen to aid the user in positioning their face for the user-facing camera 116.

Upon capturing the image using the user-facing camera 116, the resource surveillance module 106 may determine whether the captured image is a facial image 118. The image may be analyzed to determine if a face is detected. In an implementation, this may be accomplished using a facial detection process. To reduce processing complexity, the resource surveillance module 106 need not perform facial recognition to identify the face. Rather, the resource surveillance module 106 may simply use a facial detection process to determine whether there is a face in the captured image.

In another implementation, the resource surveillance module 106 may use an outline on the display screen to detect a face. If an object appears in the outline, and the pixels are filled up, then the resource surveillance module 106 determines that there is a face in the captured image. If the outline is not filled up, then the resource surveillance module 106 may instruct the camera software application to retake the picture.

If the resource surveillance module 106 does not detect a face in the captured image, then the resource surveillance module 106 may issue another facial image prompt 112. The resource surveillance module 106 may allow a user a maximum number of photo attempts. After a certain number of attempts to capture a valid facial image 118, if a face is not detected in the captured image, then the resource surveillance module 106 may deny access to the security critical resource 114 and the security critical resource 114 may be closed.

If the resource surveillance module 106 detects a face in the captured image, then the resource surveillance module 106 may store the facial image 118 according to the pre-specified storage policy 110. For example, following the pre-specified storage policy 110, the resource surveillance module 106 may send the facial image 118 to a pre-specified email address, store the facial image 118 in a local password protected folder or send the facial image 118 to a remote storage device (e.g., cloud server or network storage device).

The resource surveillance module 106 may also save a timestamp with the saved facial image 118. Other information may also be saved with the facial image 118 to aid in post-access analysis. This information may include the location where the facial image 118 was taken (e.g., Global Positioning System (GPS) coordinates). This information may also include what security critical resource 114 triggered the facial image 118 to be taken.

The resource surveillance module 106 may determine whether the facial image 118 was saved according to the pre-specified surveillance policy 110. If the facial image 118 was successfully saved, then the resource surveillance module 106 may allow access to the security critical resource 114. If the facial image 118 was not successfully saved, then the resource surveillance module 106 may deny access to the security critical resource 114 and the security critical resource 114 may be closed.

In addition to initiating the surveillance procedure upon receiving an access request 104, the resource surveillance module 106 may periodically perform the surveillance procedure while the security critical resource 114 is being used. For example, after accessing the security critical resource 114, the resource surveillance module 106 may determine that the security critical resource 114 has been open for a certain period of time. The resource surveillance module 106 may then issue another facial image prompt 112 to the user to take another facial image 118, which is then stored according to the pre-specified surveillance policy 110. This may act as a deterrent if the security critical resource 114 is left open and a malicious user attempts to use the security critical resource 114. If the facial image 118 is not taken and stored correctly, then the resource surveillance module 106 may close the security critical resource 114.

The stored facial image 118 may be made available for post-access analysis. For example, an authorized user may access the saved facial image 118 at a later time to review who was granted access to the security critical resource 114. If the authorized user sees an unauthorized user in the facial image 118, then the authorized user may take corrective actions (e.g., change the password of the security critical resource 114 or disable the security critical resource 114).

In an approach, a plurality of facial images 118 may be saved in a database for post-access analysis. The facial images 118 may be organized by timestamp or other information (e.g., location of the facial images 118). A facial recognition process may analyze the facial images 118 for possible security concerns. For example, the facial recognition process may determine whether a face in the facial images 118 is that of an authorized user. If an unauthorized user is detected, an alert may be sent to the authorized user.

In another approach, an automated image analysis may be performed to determine whether the multiple facial images 118 include a copy of the same facial image 118. For example, by analyzing the image characteristics of the facial images 118, two or more of the facial images 118 may be found to be the same. This may indicate that a photograph of a face was held up to the user-facing camera 116 instead of the face of the actual user. A malicious user may attempt to conceal their activity in this way. Upon identifying multiple copies of a facial image 118, an authorized user may be notified.

It should be noted that these approaches to post-access analysis may be performed on a computing device other than the electronic device 102. For example, a remote computing device may receive the facial images 118 and perform the post-access analysis. This may be beneficial when the electronic device 102 has limited processing resources.

The described systems and methods provide for surveillance of a security critical resource 114 that an authorized user may configure. The authorized user may then monitor who is accessing those security critical resources 114. The described systems and methods allow the user to specify which application or website that user would like to be surveilled. Then, when anyone tries to use those websites or applications, their picture is captured using the user-facing camera 116.

The described systems and methods also allow a user of an electronic device 102 (e.g., the owner of a smartphone) to verify that the information that was accessed was indeed by the user or someone that the user trusts. This solution may be used as a complimentary approach to the authentication solutions described above. The described systems and methods allow a user to perform a post-access check to see if a security critical resource 114 is being used by a malicious user.

An advantage of the described systems and methods is providing security without impacting the user experience. The solution is complementary to authentication that is already implemented on security critical resources 114. As opposed to entering multiple passwords, facial recognition or two-step authentication, the monitoring of the described systems and methods allow users to determine if the right people were accessing the websites.

The described systems and methods provide a deterrent against malicious users. The surveillance is computationally inexpensive. Furthermore, the surveillance offers peace of mind to a user as the user has information of who accessed the account and when. This information is provided in a format that is simple for the user to review.

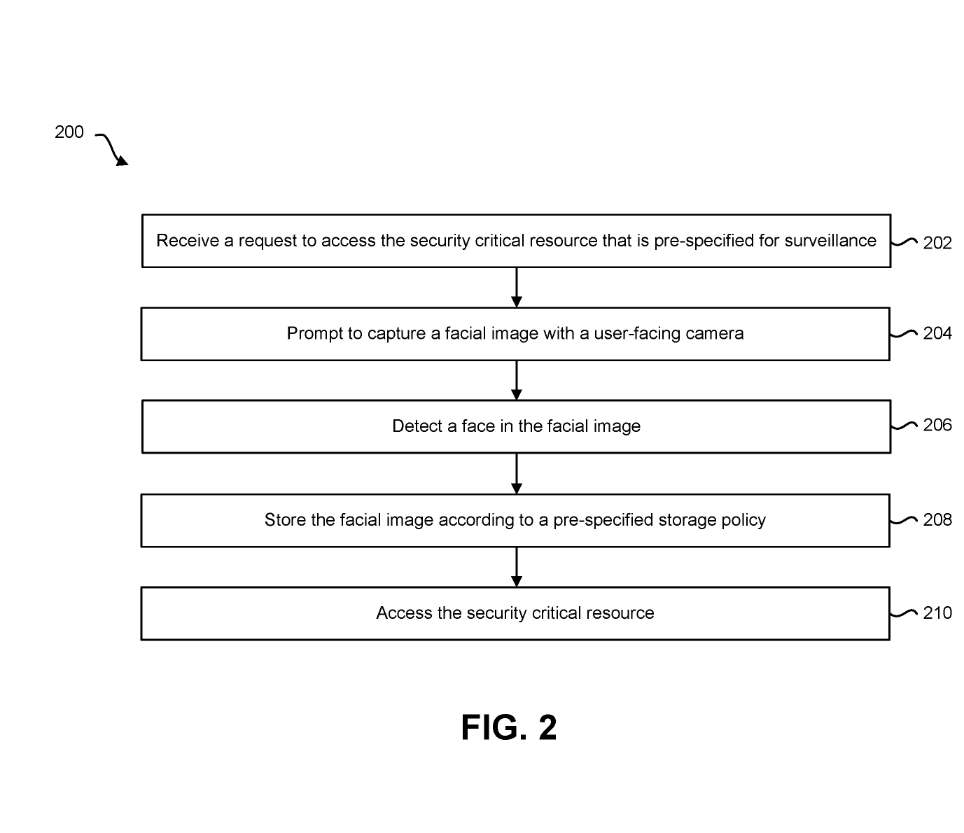

FIG. 2 is a flow diagram illustrating a method 200 for surveillance of user access to a security critical resource 114. The method 200 may be implemented by an electronic device 102 as depicted in FIG. 1. In some implementations, the method 200 may be implemented in part by a processor in the electronic device 102. In an implementation, the electronic device 102 may be a handheld mobile device that is configured with a user-facing camera 116.

The electronic device 102 may receive 202 a request 104 to access a security critical resource 114 that is pre-specified for surveillance. The security critical resource 114 may be a website or an application. The access request 104 may seek to access the website or application.

A user may pre-specify a resource as a security critical resource 114. For example, a user may specify that one or more websites are to be considered security critical resources 114. Additionally, the user may specify that one or more applications are to be considered security critical resources 114. These pre-specified security critical resources 114 may be included in a pre-specified surveillance list 108.

Upon receiving 202 the access request 104, the electronic device 102 may determine that the access request 104 is for a resource that is included in the pre-specified surveillance list 108 and is, therefore, a security critical resource 114.

The electronic device 102 may prompt 204 to capture a facial image 118 with a user-facing camera 116. For example, the electronic device 102 may issue a facial image prompt 112. The facial image prompt 112 may be a message instructing the user of the electronic device 102 to capture a facial image 118 with the user-facing camera 116. The facial image prompt 112 may also include a notification that the facial image 118 is stored for post-access analysis. The facial image prompt 112 may be displayed on a display screen of the electronic device 102.

The electronic device 102 may detect 206 a face in the facial image 118. For example, upon capturing an image using the user-facing camera 116, the electronic device 102 may use a facial detection process to determine that there is a face in the facial image 118.

The electronic device 102 may store 208 the facial image 118 according to a pre-specified storage policy 110. This may include at least one of sending the facial image 118 to a pre-specified email address, storing the facial image 118 in a local password protected folder or sending the facial image 118 to a remote storage device.

Upon successfully storing 208 the facial image 118, the electronic device 102 may access 210 the security critical resource 114. For example, the electronic device 102 may grant the user access to the security critical website or application.

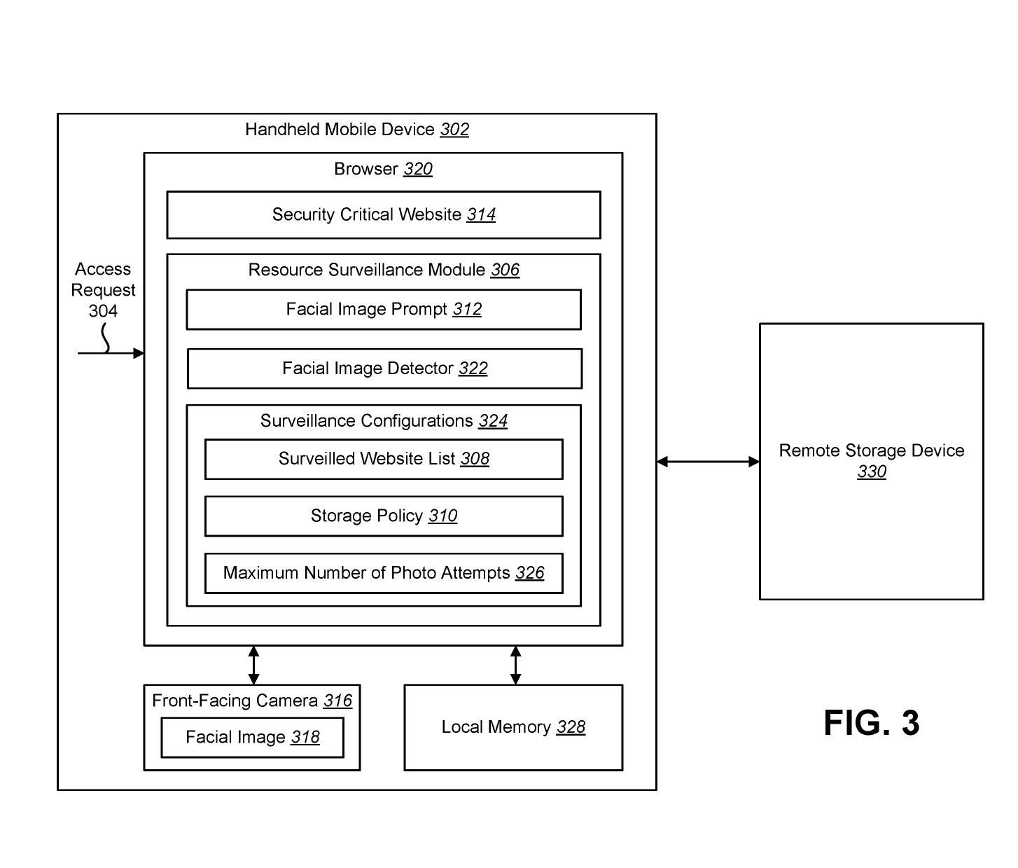

FIG. 3 is a block diagram illustrating a handheld mobile device 302 configured for surveillance of user access to a security critical website 314. The handheld mobile device 302 may be implemented in accordance with the electronic device 102 described in connection with FIG. 1. Examples of a handheld mobile device 302 include a smartphone, a tablet computer, a handheld gaming system, etc.

The handheld mobile device 302 may be configured with a browser 320 and a front-facing camera 316. The browser 320 may be a web browser that may be used to access websites.

The browser 320 may include a resource surveillance module 306. In an aspect, the resource surveillance module 306 may allow a user to enter surveillance configurations 324. A user may configure which websites are considered security critical websites 314. For example, the user may designate the Uniform Resource Locator (URL) of a website as a security critical website 314. These user-specified security critical websites 314 may be included in a surveilled website list 308.

A user may also configure a storage policy 310 for surveilled facial images 318. This may include the means (e.g., email) or location (e.g., local or remote) for saving facial images 318 that are captured by the front-facing camera 316 during a surveillance operation.

A user may further configure a maximum number of photo attempts 326. This may be the number of times that the resource surveillance module 306 allows a user to take a photo of their face before the resource surveillance module 306 denies access to the security critical website 314.

The surveillance configurations 324 may be protected by a security process. For example, if a user wishes to modify the surveillance configurations 324, the user must first enter a valid password. Other security processes may be used to protect the surveillance configurations 324.

The browser 320 may receive an access request 304 for a website. For example, a user or process may enter the address (e.g., URL) of a website into the browser 320.

Upon receiving the access request 304, the resource surveillance module 306 may determine whether the website associated with the access request 304 is a security critical website 314. The resource surveillance module 306 may check to see if the website is included in the surveilled website list 308.

If the website is included in the surveilled website list 308, then the resource surveillance module 306 may issue a facial image prompt 312. For example, the browser 320 may display a message instructing the user to take a picture of their face using the front-facing camera 316.

Upon capturing an image with the front-facing camera 316, a facial image detector 322 may detect whether the image includes a face. The facial image detector 322 may perform a facial detection procedure to determine that the captured image is a facial image 318. If a valid facial image 318 is not captured, the resource surveillance module 306 may send another facial image prompt 312 up to the maximum number of photo attempts 326, at which point access to the security critical website 314 is denied.

Upon capturing a facial image 318, the resource surveillance module 306 may store the facial image 318 according to the storage policy 310. In an implementation, the resource surveillance module 306 may send the facial image 318 to a pre-specified email address. In another implementation, the resource surveillance module 306 may store the facial image 318 in local memory 328. The facial image 318 may be stored in a password protected folder in the local memory 328. In yet another implementation, the facial image 318 may be sent to a remote storage device 330 for storage. The facial image 318 may also (optionally) be encrypted.

The facial images 318 may be stored in a database with other instances of the captured surveillance facial images 318. The database of facial images 318 may be made available for post-access analysis by an authorized user.

Upon determining that the facial image 318 was successfully stored according to the storage policy 310, the resource surveillance module 306 may allow access to the security critical website 314. At this point, any authentication procedures that are integrated with the security critical website 314 may occur. For example, after access is granted, a user may enter a username and password into the security critical website 314.

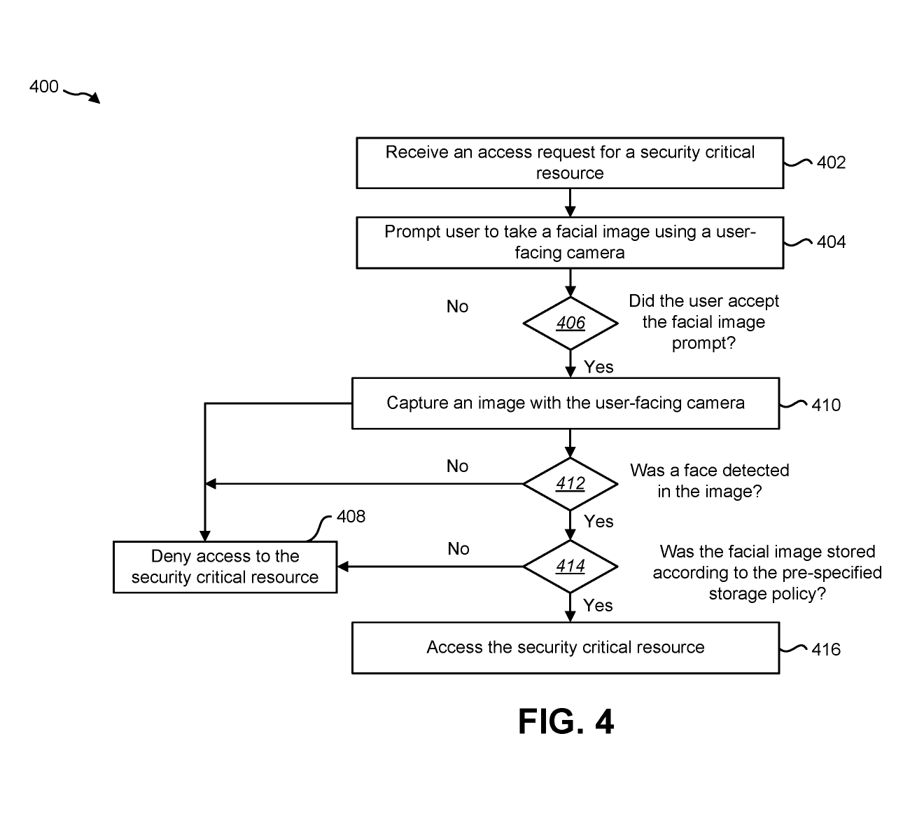

FIG. 4 is a flow diagram illustrating another method 400 for surveillance of user access to a security critical resource 114. The method 400 may be implemented by an electronic device 102 as described in connection with FIG. 1 or a browser 320 as described in connection with FIG. 3. In an implementation, the electronic device 102 may be configured with a user-facing camera 116.

The electronic device 102 may receive 402 an access request 104 for a security critical resource 114. In an implementation, a user may pre-specify a resource (e.g., website or application) as a security critical resource 114.

The electronic device 102 may prompt 404 a user to take a facial image 118 using the user-facing camera 116. For example, the electronic device 102 may issue a facial image prompt 112. The facial image prompt 112 may be a message instructing the user of the electronic device 102 to capture a facial image 118 with the user-facing camera 116. The facial image prompt 112 may also include a notification that the facial image 118 is stored for post-access analysis. The facial image prompt 112 may be displayed on a display screen of the electronic device 102.

The electronic device 102 may determine 406 whether the user accepted the facial image prompt 112. For example, the user may accept or decline to take a facial image 118. If the user declines and no image is taken in response to the facial image prompt 112, the electronic device 102 may deny 408 access to the security critical resource 114.

If the electronic device 102 determines 406 that the user accepted the facial image prompt 112, then the electronic device 102 may capture 410 an image with the user-facing camera 116. The electronic device 102 may determine 412 whether a face is detected in the image. For example, upon capturing the image, the electronic device 102 may use a facial detection process to determine whether there is a face in the image.

If there is no face detected in the image, then the electronic device 102 may deny 408 access to the security critical resource 114. Alternatively, the electronic device 102 may prompt 404 the user again to take a facial image 118. This may be done a certain number of times before denying 408 access to the security critical resource 114.

If the electronic device 102 detects 412 a facial image 118 (i.e., a face is detected in the captured image), then the electronic device 102 may determine 414 whether the facial image 118 was stored according to a pre-specified storage policy 110. For example, following a pre-specified storage policy 110, the electronic device 102 may send the facial image 118 to a pre-specified email address, store the facial image 118 in a local password protected folder or send the facial image 118 to a remote storage device 330.

If the facial image 118 was not stored according to the pre-specified storage policy 110, then the electronic device 102 may deny 408 access to the security critical resource 114. If the electronic device 102 determines 414 that the facial image 118 was successfully stored according to the pre-specified storage policy 110, then the electronic device 102 may access 416 the security critical resource 114. In other words, the electronic device 102 may grant the user access to the security critical resource 114.

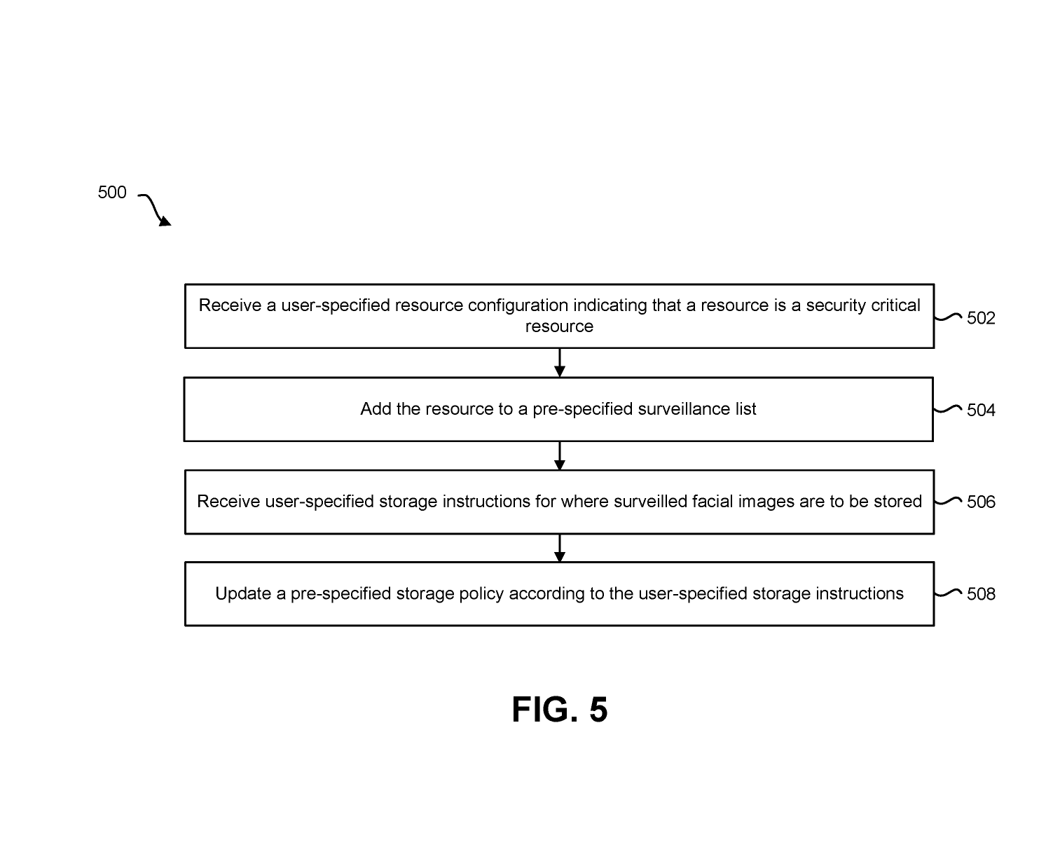

FIG. 5 is a flow diagram illustrating a method 500 for configuring surveillance of user access to a security critical resource 114. The method 500 may be implemented by an electronic device 102 as described in connection with FIG. 1 or a browser 320 as described in connection with FIG. 3.

The electronic device 102 may receive 502 a user-specified resource configuration indicating that a resource is a security critical resource 114. For example, a user may specify that a website or application is a security critical resource 114.

The electronic device 102 may add 504 the resource to a pre-specified surveillance list 108. The pre-specified surveillance list 108 may include one or a plurality of resources. In other words, the pre-specified surveillance list 108 may include one or more websites and/or one or more applications. The pre-specified surveillance list 108 may be populated with resources before initiating surveillance of the security critical resources 114.

The electronic device 102 may receive 506 user-specified storage instructions for where surveilled facial images 118 are to be stored. For example, a user may specify that facial images 118 captured during surveillance may be sent to a pre-specified email address, stored in local memory 328, sent to a remote storage device 330, saved in a password protected folder or encrypted.

Upon receiving 506 the user-specified storage instructions, the electronic device 102 may update 508 a pre-specified storage policy 110 according to the user-specified storage instructions. The electronic device 102 may use the pre-specified storage policy 110 to store the facial images 118 captured during surveillance of user access to a security critical resource 114.

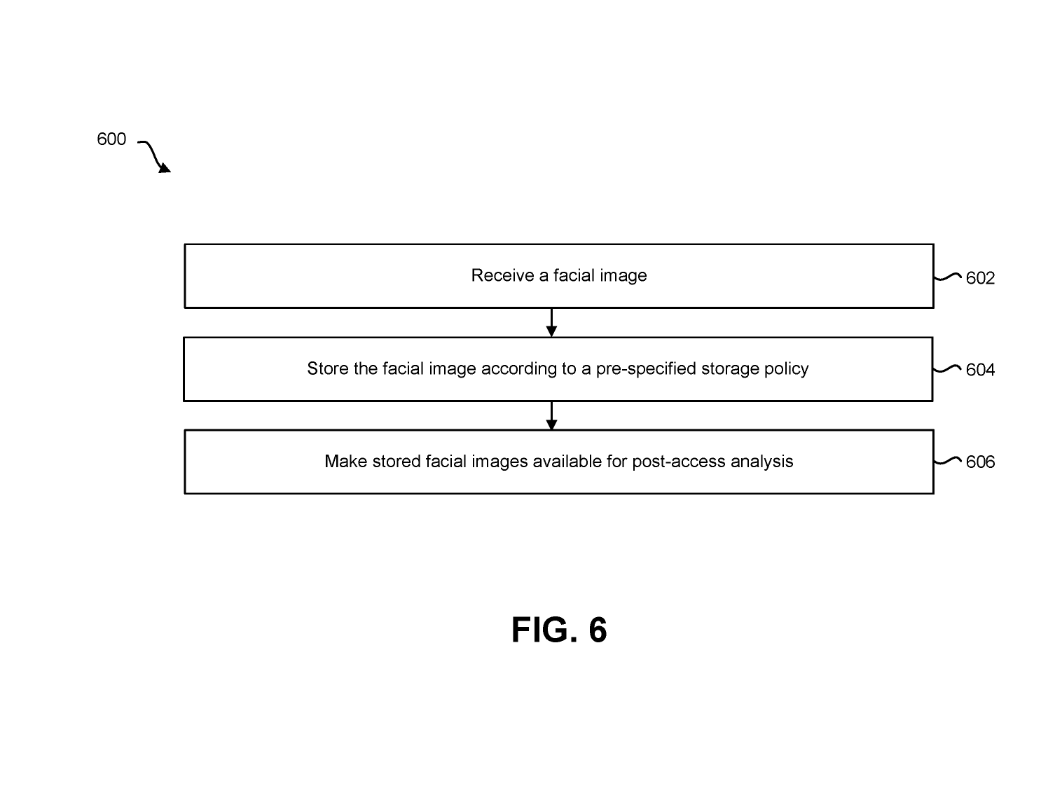

FIG. 6 is a flow diagram illustrating a method 600 for post-access analysis of security critical resource 114 surveillance. The method 600 may be implemented by an electronic device 102 as described in connection with FIG. 1 or a browser 320 as described in connection with FIG. 3.

The electronic device 102 may receive 602 a facial image 118. For example, this may be in response to a facial image prompt 112 as described in connection with FIG. 2.

The electronic device 102 may store 604 the facial image 118 according to a pre-specified storage policy 110. For example, this may be accomplished as described in connection with FIG. 2. The stored facial images 118 may be saved in a format that can be reviewed by an authorized user. For example, the facial images 118 may be stored with a timestamp and other information (e.g., GPS coordinates of where the facial image 118 was taken).

The electronic device 102 may make 606 stored facial images 118 available for post-access analysis. For example, after determining that a facial image 118 was successfully stored according to the pre-specified storage policy 110, the electronic device 102 may grant access to the security critical resource 114. An authorized user may access the saved facial image 118 at a later time to review who was granted access to the security critical resource 114.

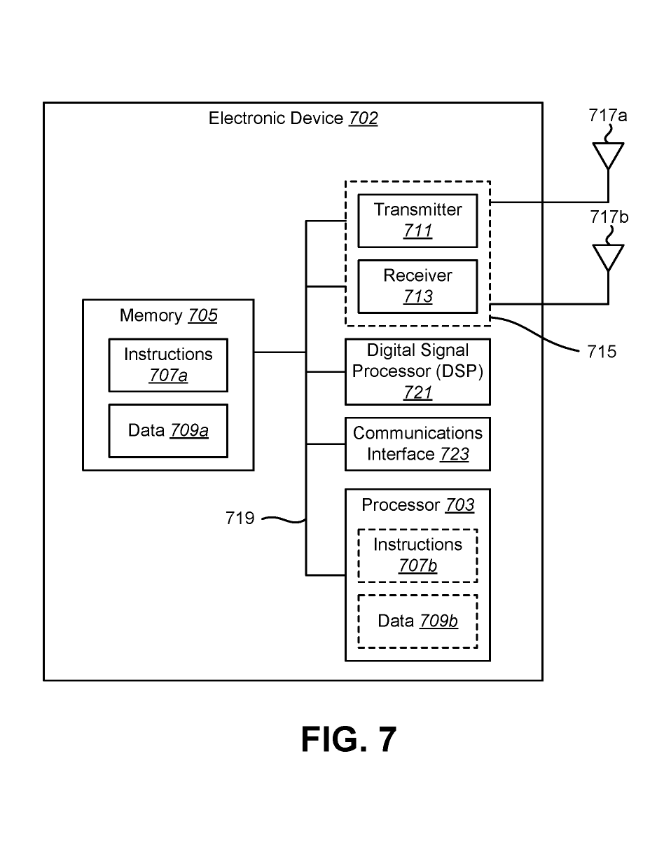

FIG. 7 illustrates certain components that may be included within an electronic device 702. The electronic device 702 may be included within a camera, video camcorder, digital camera, cellular phone, smart phone, computer (e.g., desktop computer, laptop computer, etc.), tablet device, media player, television, automobile, personal camera, action camera, surveillance camera, mounted camera, connected camera, robot, gaming console, personal digital assistants (PDA), set-top box, etc.

The electronic device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the electronic device 702, in an alternative configuration, a combination of processors (e.g., an ARM and DSP) could be used.

The electronic device 702 also includes memory 705. The memory 705 may be any electronic component capable of storing electronic information. The memory 705 may be embodied as random access memory (RAM), read-only memory (ROM), magnetic disk storage media, optical storage media, flash memory devices in RAM, on-board memory included with the processor, erasable programmable read-only (EPROM) memory, electrically erasable programmable read-only (EEPROM) memory, registers, and so forth, including combinations thereof.

Data 709a and instructions 707a may be stored in the memory 705. The instructions 707a may be executable by the processor 703 to implement one or more of the methods described herein. Executing the instructions 707a may involve the use of the data 709a that is stored in the memory 705. When the processor 703 executes the instructions 707, various portions of the instructions 707b may be loaded onto the processor 703, and various pieces of data 709b may be loaded onto the processor 703.

The electronic device 702 may also include a transmitter 711 and a receiver 713 to allow transmission and reception of signals to and from the electronic device 702. The transmitter 711 and receiver 713 may be collectively referred to as a transceiver 715. One or multiple antennas 717a-b may be electrically coupled to the transceiver 715. The electronic device 702 may also include (not shown) multiple transmitters, multiple receivers, multiple transceivers and/or additional antennas.

The electronic device 702 may include a digital signal processor (DSP) 721. The electronic device 702 may also include a communications interface 723. The communications interface 723 may enable one or more kinds of input and/or output. For example, the communications interface 723 may include one or more ports and/or communication devices for linking other devices to the electronic device 702. Additionally or alternatively, the communications interface 723 may include one or more other interfaces (e.g., touchscreen, keypad, keyboard, microphone, camera, etc.). For example, the communication interface 723 may enable a user to interact with the electronic device 702.

The various components of the electronic device 702 may be coupled together by one or more buses, which may include a power bus, a control signal bus, a status signal bus, a data bus, etc. For the sake of clarity, the various buses are illustrated in FIG. 7 as a bus system 719.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for surveillance of user access to a security critical resource, comprising:
receiving a request to access the security critical resource that is pre-specified for surveillance;
prompting to capture a facial image with a user-facing camera; and
if a face is detected in the facial image,
storing the facial image according to a pre-specified storage policy, and
accessing the security critical resource.

2. The method of claim 1, wherein if a face is not detected in the facial image, then the method further comprises denying access to the security critical resource.

3. The method of claim 1, wherein if the facial image is not stored according to the pre-specified storage policy, then the method further comprises denying access to the security critical resource.

4. The method of claim 1, wherein if no image is taken in response to the prompt, then the method further comprises denying access to the security critical resource.

5. The method of claim 1, wherein prompting to capture a facial image further comprises notifying that the facial image is stored for post-access analysis.

6. The method of claim 1, wherein the method is implemented by a browser.

7. The method of claim 1, wherein the method is implemented on a handheld mobile device.

8. The method of claim 1, wherein the security critical resource comprises a website or an application.

9. The method of claim 1, wherein storing the facial image according to the pre-specified storage policy comprises at least one of sending the facial image to a pre-specified email address, storing the facial image in a local password protected folder or sending the facial image to a remote storage device.

10. The method of claim 1, wherein the stored facial image is made available for post-access analysis.

11. An electronic device configured for surveillance of user access to a security critical resource, comprising:
a processor;
a memory in electronic communication with the processor; and
instructions stored in the memory, the instructions executable by the processor to:
receive a request to access the security critical resource that is pre-specified for surveillance;
prompt to capture a facial image with a user-facing camera; and
if a face is detected in the facial image,
store the facial image according to a pre-specified storage policy, and
access the security critical resource.

12. The electronic device of claim 11, wherein if a face is not detected in the facial image, then the instructions are further executable to deny access to the security critical resource.

13. The electronic device of claim 11, wherein if the facial image is not stored according to the pre-specified storage policy, then the instructions are further executable to deny access to the security critical resource.

14. The electronic device of claim 11, wherein if no image is taken in response to the prompt, then the instructions are further executable to deny access to the security critical resource.

15. The electronic device of claim 11, wherein the security critical resource comprises a website or an application.

16. A computer-program product for surveillance of user access to a security critical resource, comprising a non-transitory tangible computer-readable medium having instructions thereon, the instructions comprising:
code for causing an electronic device to receive a request to access the security critical resource that is pre-specified for surveillance;
code for causing the electronic device to prompt to capture a facial image with a user-facing camera; and
if a face is detected in the facial image,
code for causing the electronic device to store the facial image according to a pre-specified storage policy, and
code for causing the electronic device to access the security critical resource.

17. The computer-program product of claim 16, wherein if a face is not detected in the facial image, then the instructions further comprise code for causing the electronic device to deny access to the security critical resource.

18. The computer-program product of claim 16, wherein if the facial image is not stored according to the pre-specified storage policy, then the instructions further comprise code for causing the electronic device to deny access to the security critical resource.

19. The computer-program product of claim 16, wherein if no image is taken in response to the prompt, then the instructions further comprise code for causing the electronic device to deny access to the security critical resource.

20. The computer-program product of claim 16, wherein the security critical resource comprises a website or an application.
